(19) United States
(12) Patent Application Publication
(10) Pub. No.: US 2016/0265277 A1
(43) Pub. Date: Sep. 15, 2016

(54) STEP LADDER WITH RUNGS HAVING BENT FRONT FACES FOR IMPROVED LEG SUPPORT

(71) Applicant: Scott A. Masters, Solana Beach, CA (US)

(72) Inventor: Scott A. Masters, Solana Beach, CA (US)

(21) Appl. No.: 14/656,393

(22) Filed: Mar. 12, 2015

(51) Int. Cl. E06C 7/08; E06C 1/38

(52) U.S. Cl. CPC E06C 7/085; E06C 1/38

(57) ABSTRACT

A step ladder. Two side rails and two support legs are connected to a top cap. Two locking spreader bars are connected between the support legs. The locking spreader bars hold the two side rails at a side rail angle. Ladder rungs are rigidly connected to the side rails. At least one of the ladder rungs has a bend to form a bent rung front face. The bent rung front face has a bent rung front face angle that is less than the side rail angle. To use the step ladder, the user will stand on a ladder rung and rest at least one of his legs against a bent rung front face. The increased angle of the bent rung front face will provide comfortable support for the user. In a preferred embodiment, the bent rung front face angle is vertical at 90 degrees.

The present invention relates to ladders and in particular to ladders adapted for improved leg comfort and support.

### BACKGROUND OF THE INVENTION

FIG. 1 shows a perspective view and FIG. 2 shows a side view of prior art step ladder 1. Ladder 1 includes side rails 10-11, rungs 3-7 and top cap 8. Ladder 1 also includes non-climbing rear support legs 38 and locking spreader bars 39. Locking spreader bars 39 hold step ladder 1 so that it is in the general shape of the letter “A” for stability. Side rails 10-11 are angled as shown for ease of use for the user. Rungs 3-7 are attached to side rails 10 and 11 via rivets 13. Each rung 3-7 includes a corresponding front face 3a-7a that extends downward from the horizontal section of the rung. Rivets 13 are riveted through front faces 3a-7a of rungs 3-7 and also front faces 11a and 10a of side rails 10 and 11. Therefore, front faces 3a through 7a are at angle that corresponds to the angle of side rails 10 and 11. This angle may vary slightly between prior art step ladders, but a common angle allows for the ladder to be at approximately a 110 degree tilt (FIG. 2).

FIG. 2 shows the leg of a user who is standing on rung 3 of ladder 1. For better stability and support the user will brace his leg on the next rung that is above the rung upon which he is standing. For example, in FIG. 2 the user is standing on rung 3 and the user has braced his leg against rung 4 for better support. As the user leans into rung 4 the shin of his leg presses against angled face 4a for support. Rung 4 provides good support for the user. However, after a short period of time the user will begin to feel pain from a pressure point due to the lower edge of angled face 4a pressing into the user's leg.

There have been numerous attempts to find a solution to this problem, but none have adequately succeeded. For example, U.S. Pat. No. D372,989 shows a padding attached to a ladder with Velcro® so that the legs of the user will rest against the padding instead of the hard rungs. U.S. Pat. No. 3,531,878 shows a boot with a shin protection device built into the boot. This boot can be worn while on a ladder to cushion the hard rungs. U.S. Pat. No. 4,401,187 shows a platform that can be attached to ladder rungs. The user can stand on the platform and will then be able to stand more vertical so that he does not have to lean against the rungs. U.S. Pat. No. 2,518,107 shows an attachable cushioned shin shield for step ladders. U.S. Pat. No. 6,006,863 shows a rung with cushioning for increased comfort. U.S. Pat. No. 6,415,890 also shows a rung with cushioning for increased comfort. U.S. Pat. No. 6,729,438 also shows a rung with cushioning for increased comfort. U.S. Publication 20110005863 also shows a rung with cushioning for increased comfort.

What is needed is a better ladder that allows for pain free support to the user.

### SUMMARY OF THE INVENTION

The present invention provides a step ladder. Two side rails and two support legs are connected to a top cap. Two locking spreader bars are connected between the support legs and the two side rails. The locking spreader bars hold the two side rails at a side rail angle. Ladder rungs are rigidly connected to the side rails. At least one of the ladder rungs has a bent front face. The bent front face has an angle that is less than the side rail angle. To use the step ladder, the user will stand on a ladder rung and rest at least one of his legs against the bent front face. The decreased angle of the bent front face will provide comfortable support for the user by creating an angle to match the user's leg. In a preferred embodiment, the angle of the bent front face is vertical at 90 degrees.

### BRIEF DESCRIPTION OF THE DRAWINGS

FIG. 1 shows a perspective view of a prior art ladder.

FIG. 2 shows a side view of the prior art ladder of FIG. 1.

FIG. 3 shows a perspective view of a preferred ladder.

FIG. 4 shows a side view of the preferred ladder of FIG. 3.

FIG. 5 shows a detailed perspective view of a rung having a bent front face.

FIG. 6 shows a front view of the preferred ladder of FIG. 3.

FIG. 7 shows another side view of the preferred ladder of FIG. 3.

FIG. 8 shows another preferred embodiment of the present invention.

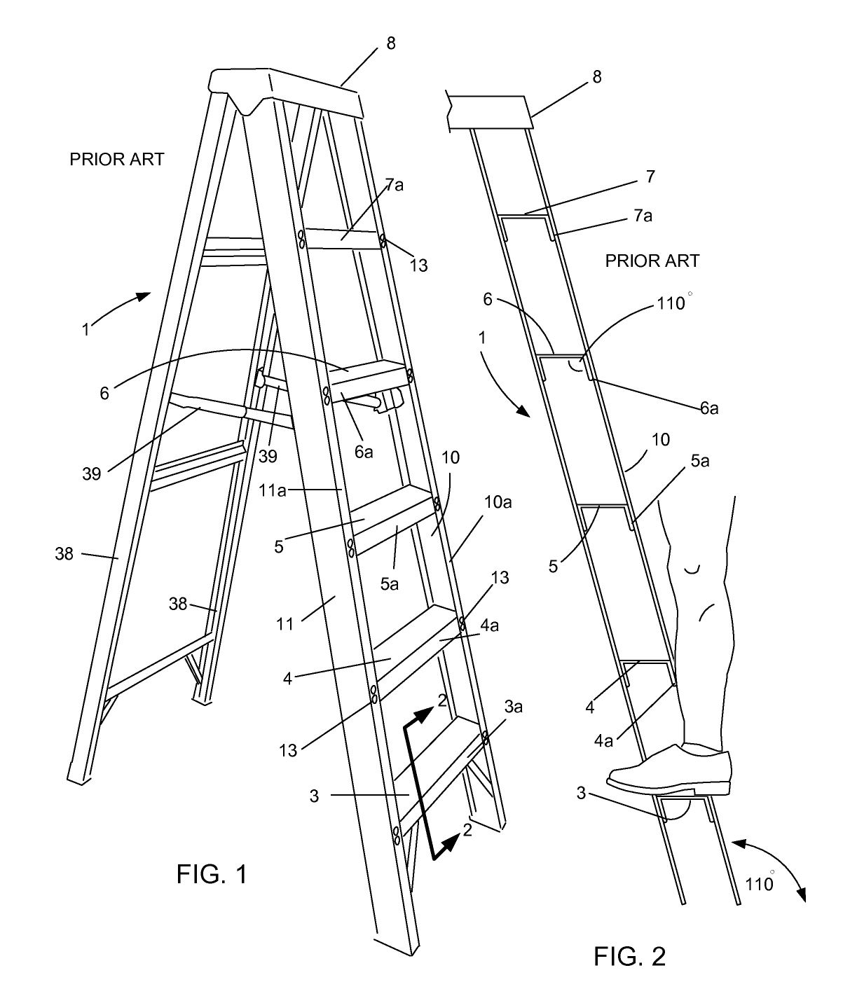

### DETAILED DESCRIPTION OF THE PREFERRED EMBODIMENTS

FIG. 3 shows a perspective view and FIG. 4 shows a side view of preferred aluminum step ladder 20. Ladder 20 includes rungs 3-7 and top cap 8. Ladder 20 also includes non-climbing rear support legs 38 and locking spreader bars 39. Locking spreader bars 39 hold step ladder 20 so that it is in the general shape of the letter “A” for stability. Side rails 10-11 are held at a side rail angle as shown for ease of use for the user. For example, the side rail angle of ladder 20 is approximately 110 degrees (FIG. 4). The side rail angle is the angle between side rail front face 50a and the ground. Rungs 22-25 include corresponding rung front faces 22a-25a. Front faces 22a-25a are bent so that their front face angle is less than the side rail angle of ladder 20. The front face angle is the angle between the top of the ladder rung and the front face of the ladder rung. For example, as shown in FIG. 4, the angle between rung 24 and rung front face 24a is 90 degrees and is referred to as a front face angle. For the preferred embodiment shown in FIG. 4, the front face angles for front faces 22a-25a are all approximaly 90 dteegrees. The 90 degree front face angles for front faces 22a-25a are each less than the side rail angle of 110 degrees shown in FIG. 4. It should be noted that the front face angle between rung 21 and front face 21a is 110 degrees to match the side rail angle of 110 degrees. Front face 21a has not been bent.

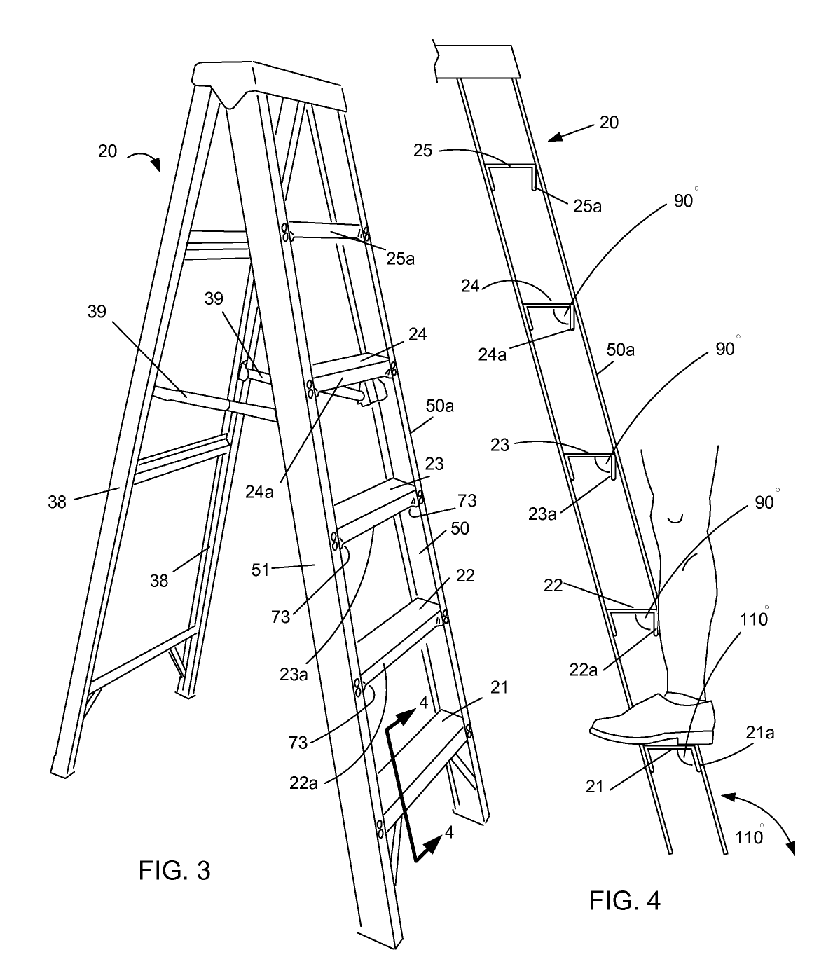

The front face angle of front faces 22a-25a allows for better support and comfort to the user. For example, as shown in FIG. 4, the user is standing on rung 21 and is leaning his leg against rung 22 for support. Front face 22a is in alignment with the shin of the user's leg. The full length of front face 22a supports the user's leg. This is in stark contrast to front face 4a of prior art ladder 1 (FIG. 2). The bottom edge of front face 4a abuts the user's shin causing pain and discomfort that increases with time. In contrast front face 22a is vertical and more comfortably supports the user's leg which is also vertical.

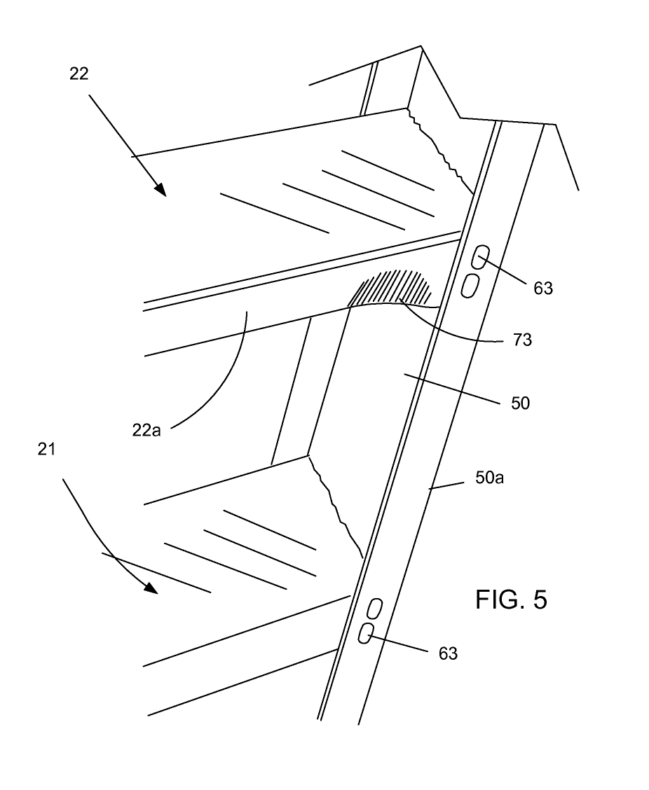

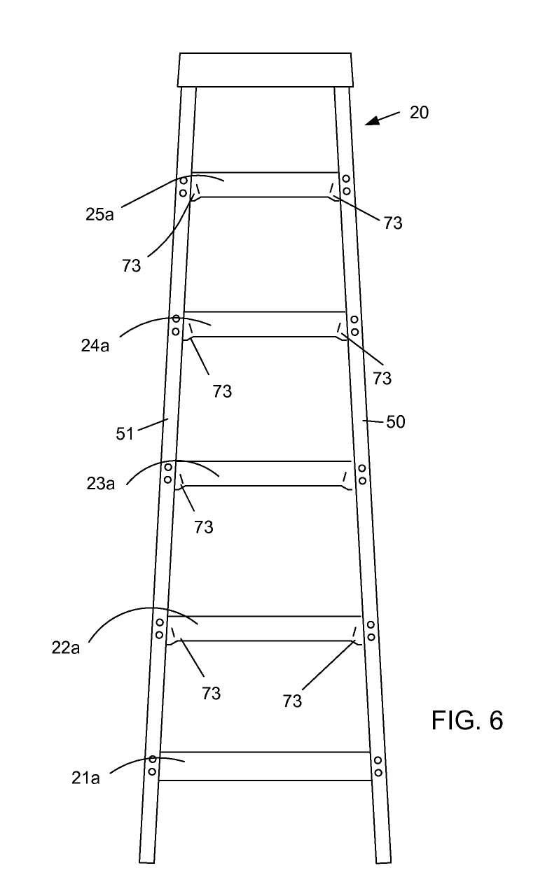

FIG. 5 shows a detailed perspective view of rung 22 and front face 22a. Rung 22 is rigidly connected to side rails 50 and 51 via rivets 63 (see also FIG. 3). In a preferred embodiment, bends 73 of front face 22a occur just outside of side rail front faces 50a and 51a. See also FIG. 6 which shows a front view of ladder 20.

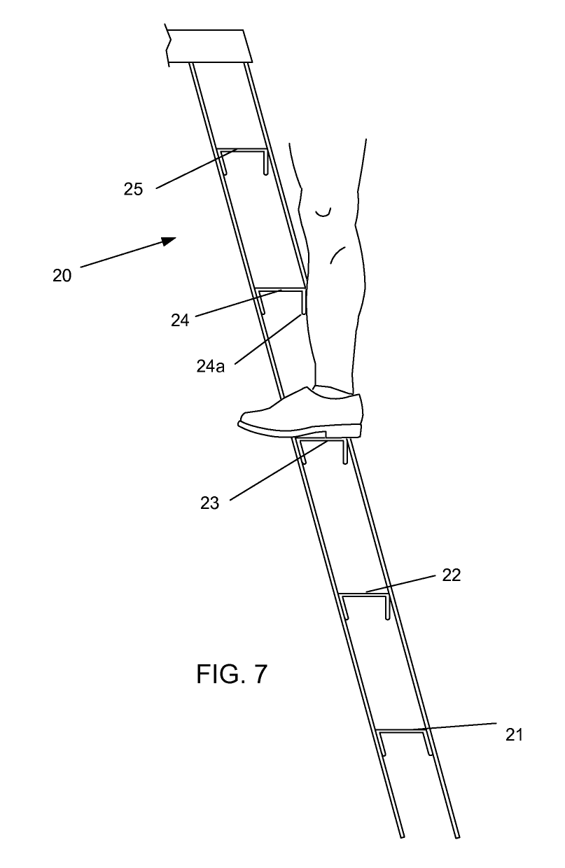

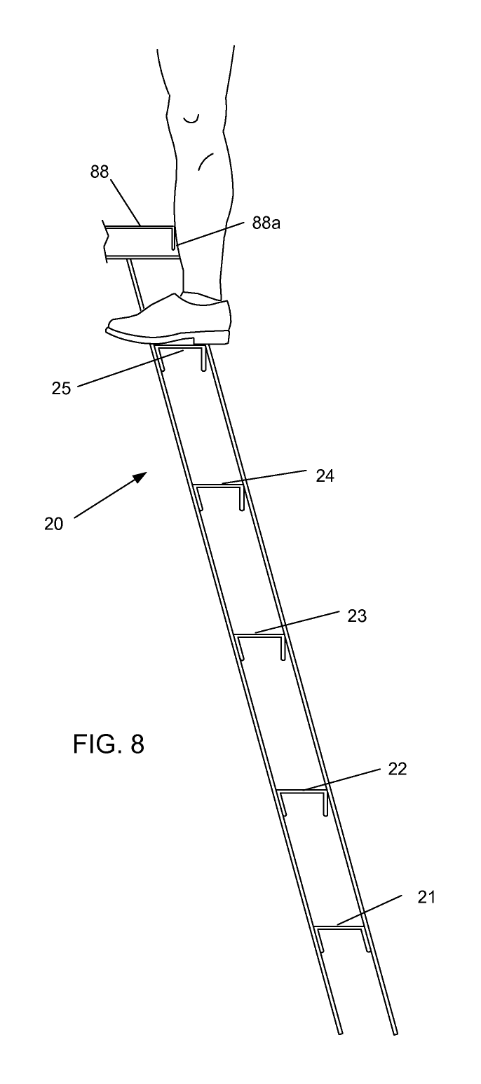

A user on step ladder 20 can step on rungs 21-24 and be comfortably supported by bent front faces of rungs 22a-25a in a fashion similar to that described above. For example, in FIG. 7 the user is standing on rung 23 and is supported by bent vertical front face 24a. It should also be noted that in a preferred embodiment, top cap 88 can be modified so that its front face is bent vertically to provide support for the user's leg. For example, FIG. 8 shows the user standing on rung 25. His leg is supported by bent front face 88a of top cap 88.

Although the above-preferred embodiments have been described with specificity, persons skilled in this art will recognize that many changes to the specific embodiments disclosed above could be made without departing from the spirit of the invention. Therefore, the attached claims and their legal equivalents should determine the scope of the invention

What is claimed is:

1) A step ladder, comprising:
A. two side rails,
B. a top cap connected to said two side rails,
C. two support legs connected to said top cap,
D. two locking spreader bars connected between said two support legs and said two side rails, said two locking spreader bars holding said two side rails at a side rail angle, and
E. a plurality of ladder rungs rigidly connected to said side rails, wherein at least one of said plurality of ladder rungs comprises a bend to form a bent front face having an angle that is less than said side rail angle.

2) The step ladder as in claim 1, wherein each of said side rails further comprises a side rail front face, wherein said plurality of ladder rungs are rigidly connected to said two side rails at said side rail front faces.

3) The step ladder as in claim 1, wherein said side rail angle is approximately 110 degrees and wherein said bent front face angle is approximately 90 degrees.

4) The step ladder as in claim 1, wherein a user is capable of standing on at least one of said plurality of ladder rungs while resting his leg against another of said plurality of ladder rungs for stability and support.

5) The step ladder as in claim 1, wherein the user rests his leg against said bent front face for stability and support.

6) A method for using a step ladder, comprising the steps of:
A. approaching said step ladder, said step ladder comprising:
1. two side rails,
2. a top cap connected to said two side rails,
3. two support legs connected to said top cap,
4. two locking spreader bars connected between said two support legs and said two side rails, said two locking spreader bars holding said two side rails at a side rail angle, and
5. a plurality of ladder rungs rigidly connected to said side rails, wherein at least one of said plurality of ladder rungs comprises a bend to form a bent front face having an angle that is less than said side rail angle,
B. standing on at least one ladder rung, and
C. resting at least one leg against said bent front face.

7) The method as in claim 6, wherein each of said side rails further comprises a side rail front face, wherein said plurality of ladder rungs are rigidly connected to said two side rails at said side rail front faces.

8) The method as in claim 6, wherein said side rail angle is approximately 110 degrees and wherein said bent front face angle is approximately 90 degrees.

9) The method as in claim 6, wherein a user is capable of standing on at least one of said plurality of ladder rungs while resting his leg against another of said plurality of ladder rungs for stability and support.

10) The method as in claim 6, wherein the user rests his leg against said bent front face for stability and support.
